(19) United States
(12) Patent Application Publication
(10) Pub. No.: US 2008/0005393 A1
(43) Pub. Date: Jan. 3, 2008

(54) Duplicator

(75) Inventors: Sung-Jung Wang, Taipei County (TW); Tai-Ching Chiu, Taipei County (TW)

Correspondence Address: BIRCH STEWART KOLASCH & BIRCH, PO BOX 747, FALLS CHURCH, VA, 22040-0747, US

(73) Assignee: Chon-Min Wu

(21) Appl. No.: 11/400,306

(22) Filed: Apr. 10, 2006

(51) Int. Cl. G06F 13/00

(52) U.S. Cl. 710/33

(57) ABSTRACT

A duplicator for duplicating data of a source storage device to one or more target storage devices includes a source connector to connect the source storage device, target connectors to connect the target storage devices and a data transferring unit. The data transferring unit includes a source control module connected to the source connector, target control modules connected to the target connectors and a switch module connecting the source control module and the target control modules. A data input port connects the source control module. The source control module can switch the data transferring to the switch module from the source connector or form the data input port.

### BACKGROUND OF THE INVENTION

1. Field of the Invention

The present invention relates generally to a computer peripheral device, and more particular to a duplicator to duplicating data from one storage device to one or more storage devices.

2. Description of the Related Art

In present days, personal computer (PC), including notebook and other portable computers, is a common electron product with a high calculating speed and huge storage size. Typically, a computer includes a host, screen, keyboard, and mouse etc. The host includes CPU (central processing unit), memory, mass storage device, and power supply etc. The mass storage device has various types, including floppy disk, hard disk, CD-ROM, CD-RW, DVD-ROM, DVD-RW, flash memory, nonvolatile solid-state storage device, tape and other relative device and combination.

In some certain industries, such as PC manufacturers and mass storage device manufacturers, it needs to duplicate data to one or more mass storage devices, such as hard disk, flash memory and the like. It is very important to have a duplicator for duplicating data stably and quickly.

Bodo, U.S. Pat. No. 5,777,811, taught a data duplicating system, which is a standard computer system and is broadly utilized in present day's PCs. Basically, Bodo's system sends the copied data to a main memory, which usually is RAM (Random Access Memory), then writes the copied data to a target storage device. Such data transfer system is reliable but the transfer speed will be affected by the accessing, read and write, and calculating speed of CPU. It also is affected by the limitation of the RAM, which only can read or write in a single time, and the specifications of different memories. The result of sharing the main memory is that the duplicator must match computer, and it usually can not meet the requirement. The dynamic memory is chosen to have a greater size of main memory in the computer. The dynamic memory needs to charge repeatedly that affects the bandwidth of data transferring. In addition, while the data is transferred from the main memory to the target devices, the data is transferred to the target devices one by one, not simultaneously, that reduces the data transferring speed greatly for such duplicator with mass duplication capacity.

Ravid's invention, U.S. Pat. No. 6,131,141, discloses a HDD (hard disk drive) duplicator, which is connectable to a computer as operation interface. The patent taught means for controlling the copied data flowing to target HDDs from the source HDD directly. Between the data path, there is no memory buffer for temporary storage of copied data to have a high speed of data duplication. Ravid's invention improves the Bodo's invention but introduces some new problems. Ravid provides no memory buffer between the source HDD and the target HDDs that will cause the variety of the flow rate of the copied data may not be absorbed. Almost all storage devices have the same problem. Although the storage devices with the same specification have substantially the same average transferring speed, the instant speed thereof changes all the time that make two storage devices with the same specification still have different data transferring speed in an identical time. As a result, the devices have to wait for the device with the slowest speed in every data transferring that causes the transferring speed still has its limitation. In the meantime, because there is several target devices, it has to amplify the signal from the source device to enhance the data power, such that the signal is reduced because the target device take too much current. To avoid above drawback, in addition to the switches between the devices, the power enhancing circuitry may be provided. But the power enhancing circuitry will cause extra delay some time that makes the speed of data transferring is slowed than the standard process.

Another U.S. patent issued to Chou, Pat. No. 6,931,459, discloses a data duplicator, which provides FIFO (First-In-First-Out) memories to be the buffer of data transferring. The patent also discloses an external data source, which is connected to a multiplexer of the duplicator, to transfer the copied data to the target storage devices. It needs an independent circuitry to connect the external data source and that is not an optimal design.

### SUMMARY OF THE INVENTION

The primary objective of the present invention is to provide a duplicator with a reliable, faster and efficient data duplication function.

According to the objective of the present invention, a duplicator for duplicating data of a source storage device to at least one target storage device includes a source connector to connect the source storage device, at least one target connector to connect the at least one target storage device and a data transferring unit including a source control module, a switch module and at least one target control module. The source control module includes a switch connected to the source connector and a controller controlling the switch to transfer the data of the source storage device to the switch module. The switch module receives the data from the source control module and transferring the data to the at least one target control module. The target control module includes a switch connected to the target connector and a controller controlling the switch to transfer the data from the switch module to the source storage device. A data input port connects the switch of the source control module, wherein the controller of the source control module controls the switch to switch the data transferring to the switch module from the source connector or form the data input port.

### BRIEF DESCRIPTION OF THE DRAWINGS

FIG. 1 is a perspective view of a first preferred embodiment of the present invention;

FIG. 2 is a circuitry diagram of the first preferred embodiment of the present invention;

FIG. 3 is a circuitry diagram of the source control module of the first preferred embodiment of the present invention;

FIG. 4 is a circuitry diagram of the target control module, which connects the target connector only, of the first preferred embodiment of the present invention;

FIG. 5 is a circuitry diagram of the target control module, which connects both of the target connector and the data output port, of the first preferred embodiment of the present invention;

FIG. 6 is a circuitry diagram of an application of the first preferred embodiment of the present invention;

FIG. 7 is a circuitry diagram of another application of the first preferred embodiment of the present invention; and

FIG. 8 is a circuitry diagram of the target control module of a second preferred embodiment of the present invention.

### DETAILED DESCRIPTION OF THE INVENTION

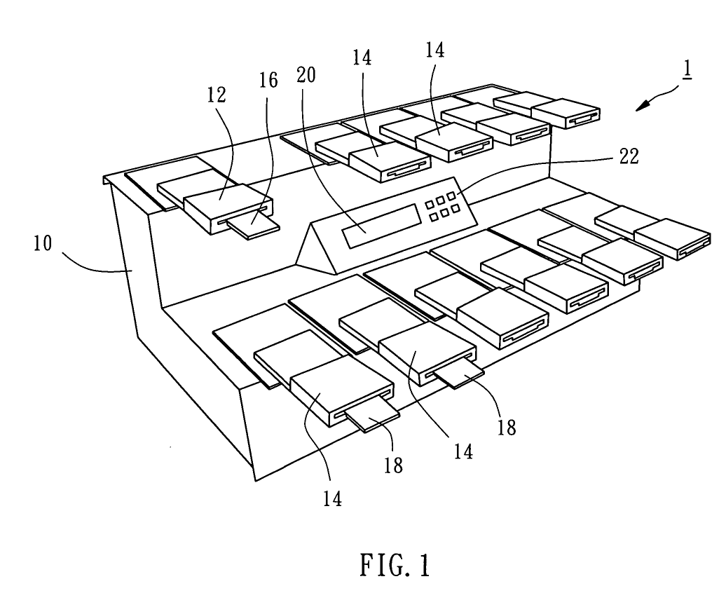

As shown in FIG. 1, a duplicator 1 of the first preferred embodiment of the present invention includes a case 10, on which a source connector 12 and a plurality of target connectors 14 are provided. The connectors 12 and 14 are adapted to insert flash memory cards 16, 18 therein. The flash memory cards may be [symbol] Compact Flash Card (CF card), Smart Media Card (SM card), Multi-Media Card (MMC card), Memory Stick (MS) [symbol] Secure Digital Card (SD card) or other types of flash memories. The connectors 12 and 14 also may be for other mass storage devices, such as hard disk, floppy disk, compact disk (CD), digit video disk (DVD) or other types of mass storage device. The source connector 12 and the target connectors 14 may be designed for different types of storage devices, such as the source connector may be connected to a hard disk drive, and the target connectors may be connected to flash memories.

The case 10 has a liquid crystal display (LCD) 20 to show relative information, a plurality of keys 22 for setting, and ports (not shown) to connect some peripheral devices, such as keyboard, series communication or the relative devices.

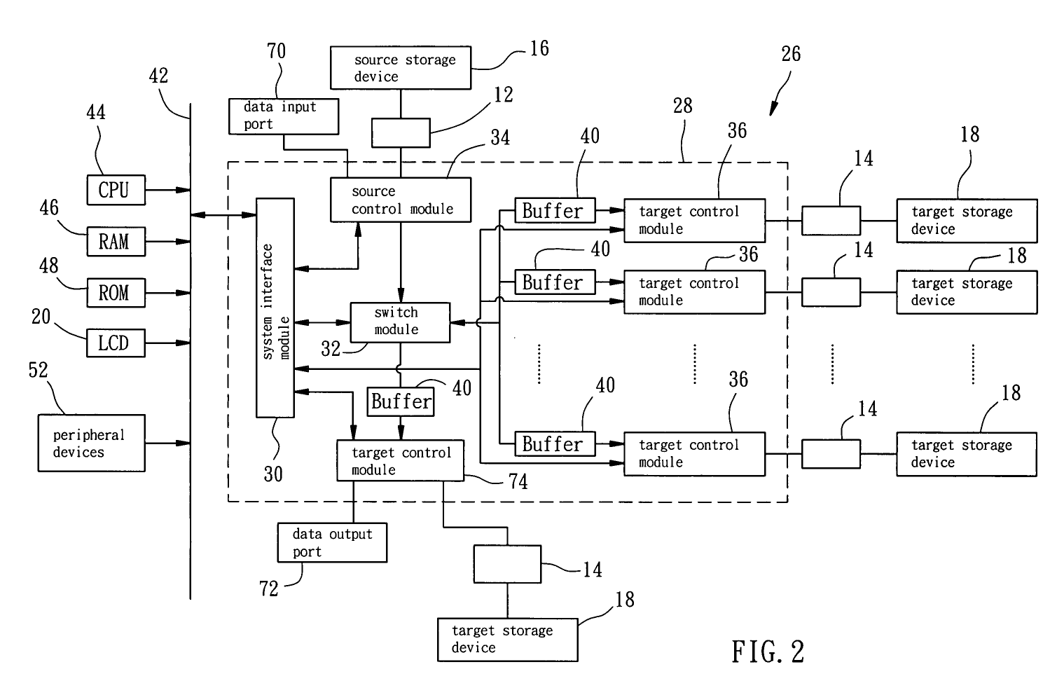

A circuit board (not shown) is received in the case 10, which a circuitry 26 is shown in FIG. 2. The circuitry 26 includes a data transferring unit 28, which has a system interface module 30, a switch module 32, a source control module 34, a plurality of target control modules 36 and 74, and a plurality of buffers 38. The source control module 34 and the target control modules 36 are connected to the source connector 12 and the target connectors 14 respectively. The system interface module 30 connects a CPU 44, a RAM 46, a ROM 48, the LCD 20, and other peripheral devices through a data/control-signal bus to transfer control signal to the switch module 32, the source control module 34 and the target control modules 36 etc. The system interface module 30 may separate the interference between the modules to make the main computer still executing programs when the data is duplicated. The switch module 32 receives the data from the source control module 34, and transfers it to the predetermined target control modules 36. The buffers 38 are provided on data paths between the switch module 32 and the target control modules 36 respectively.

The circuitry 26 further has a data input port 70 and a data output port connected to the source control module 34 and the target control module 74.

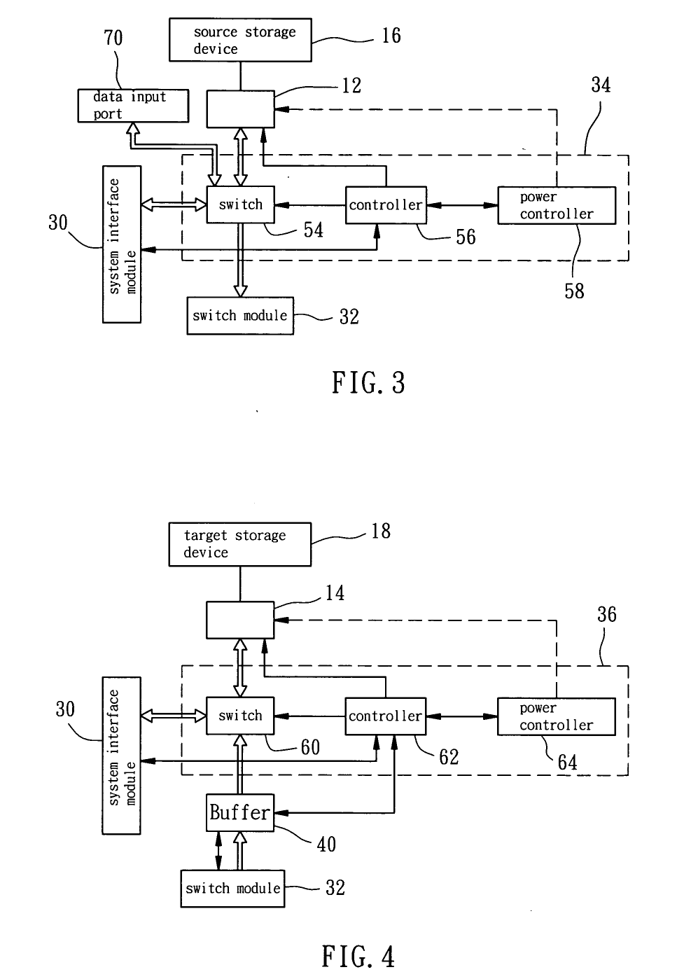

As shown in FIG. 3, the source control module 34 includes a switch 54, a controller 56 and a power controller 58. The controller 56 may receive the control signal from the system interface module 30 to control the source connector 12, the switch 54 and the power controller 58. The power controller 58 supplies the source connector 12 electricity. The switch 54 is connected to the source connector 12 to transfer the copied data from the source storage device 16 to the switch module 32. And then, the switch module 32 transfers the copied data to the predetermined target control modules 36, 74 through the buffers 40.

The data input port 70 is connected to the switch 54 of the source control module 34 and is controlled by the controller. The data input port 70 is connectable to an external data source (not shown), and the controller 56 controls the switch 54 to choose the copied data transferred to the switch module 32 is from the source connector 12 or from the data input port 70.

As shown in FIG. 4, the target control modules 36 are similar to the source control module 34, including a switch 60, a controller 62 and a power controller 64. Same as above, the controller 62 may receive the control signal from the system interface module 30 to control the target connector 14, the switch 60, the power controller 64 and the buffers 38 or receive control signals from above elements. The power controller 64 supplies the target connector 14 electricity. The switch 54 is connected to the target connector 14 to transfer the copied data from the buffer 38 to the target connector 14.

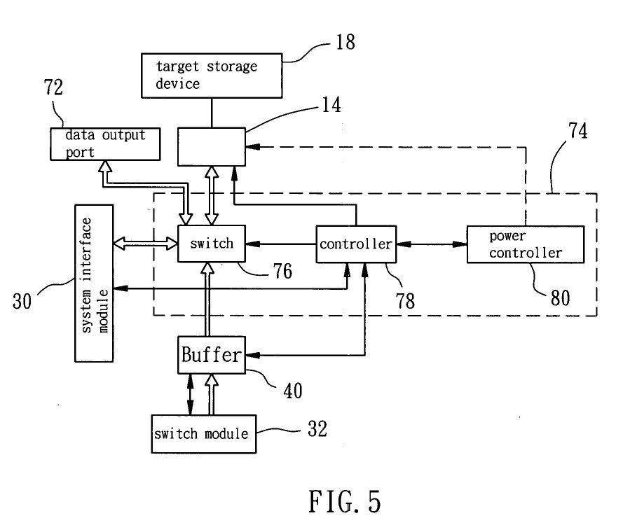

FIG. 5 shows the target control module 74, which includes a switch 76, a controller 78 and a power controller 80. The different is that both of the target connector 14 and the data output port 72 are connected to the switch 76. The controller 78 controls the switch 76 to transfer data to the target connector 14 or to the data output port 72.

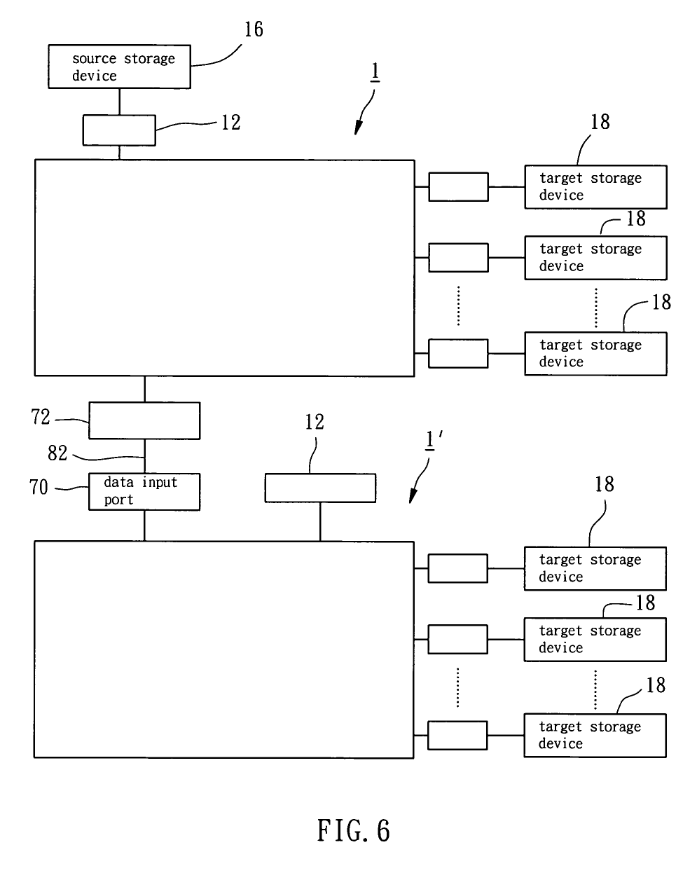

In an application of the present invention, a cable 82 is used to connect two duplicators 1 and 1′ of the present invention via the data input port 70 and the data output port 72, as shown in FIG. 6. Thus, data of the source storage device 16 connected to the duplicator 1 may be transferred to the duplicator 1′ and write into the target storage devices 18 of the duplicator 1′. As a result, more copies of the copied data are made in a single duplication process. It could series connect more duplicators of the present invention by the way above.

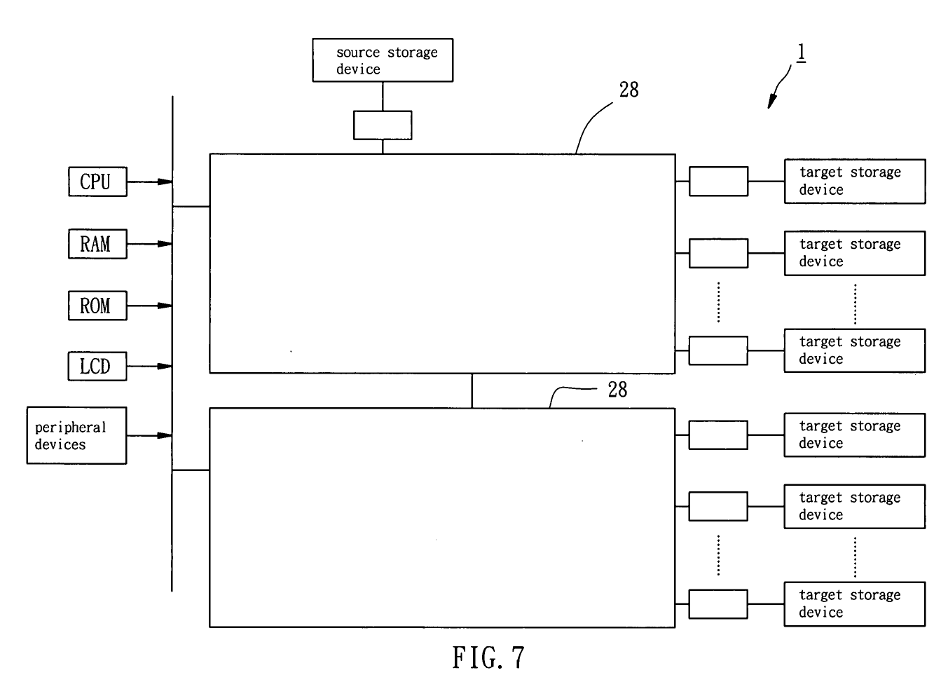

In another application, as shown FIG. 7, there are two data transferring units 28 in one duplicator 1 of the present invention that the duplicator 1 may have double of the target connectors.

The purposes of above applications are increasing the copies of duplication. It achieves by making the input and output with the same interface, such that the duplicators or the data transferring units may be series connected.

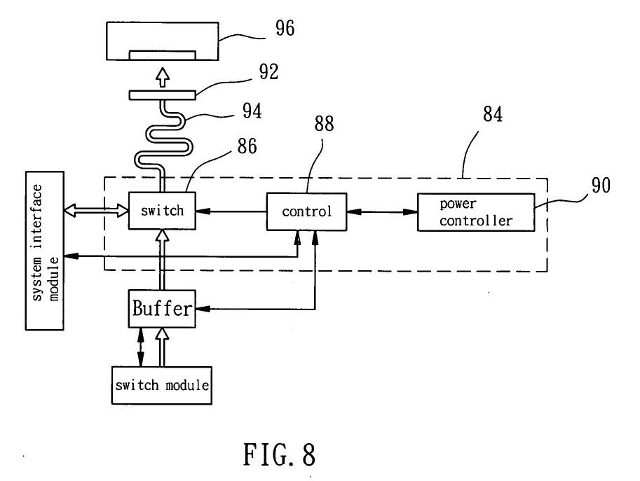

FIG. 8 shows a target control module 84 of a second preferred embodiment of the present invention, same as above, which includes a switch 86, a control 88, and a power controller 92. A cable 94 has an end connected to the switch 86 and a connector 92 at the other end thereof to detachably connect a target connector 96. The cable 94 is much longer than the distance between the switch 86 and the target connector 96. When the target connector 96 is removed, the connector 92 may be drawn out of the duplicator and connected to another device (not shown) to transfer the data of the source storage device thereto.

The character of the present invention is using the data duplication circuitry to be the path of data input and output. In other words, there is no need to give extra circuit for the data input and output that enlarge the flexibility of the system.

It has to be noted that the number and the memory size of the buffers depend on the system requirement, and the buffers may be provided between the source control module and the switch module or between the target control module and the switch modules, like the embodiments of the present invention, or both.

What is claimed is:

1. A duplicator for duplicating data of a source storage device to at least one target storage device, comprising:
a source connector to connect the source storage device;
at least one target connector to connect the at least one target storage device;
a data transferring unit including a source control module, a switch module and at least one target control module;
said source control module including a switch connected to said source connector and a controller controlling said switch to transfer the data of the source storage device to said switch module;
said switch module receiving the data from said source control module and transferring the data to said at least one target control module;
said at least one target control module including a switch connected to said target connector and a controller controlling said switch to transfer the data from the switch module to the source storage device; and
a data input port connecting said switch of said source control module, wherein said controller of said source control module controls said switch to switch the data transferring to said switch module from said source connector or form said data input port.

2. The duplicator as defined in claim 1, further comprising a system interface module connecting said source control module, said switch module and said at least one target control module to a central processing unit, a random access memory and a display.

3. The duplicator as defined in claim 1, wherein said source control module further includes a power controller to supply said source connector electricity.

4. The duplicator as defined in claim 1, wherein said at least one target control module further includes a power controller to supply said source connector electricity.

5. The duplicator as defined in claim 1, further comprising a data output port, wherein said data output port is connected to said switch of said target control module, and said controller of said target control module controls said switch to transfer the data to said target connector or to said data output port.

6. The duplicator as defined in claim 1, wherein said target control module further includes a cable with a connector at an end thereof, and an end of said cable is connected to said switch and said connector is detachably connected to said target connector whereby when said target connector is removed from said connector, said connector can connect an external device.
